(19) United States
(12) Patent Application Publication
(10) Pub. No.: US 2020/0351425 A1
(43) Pub. Date: Nov. 5, 2020

(54) DRIVING RECORDER

(71) Applicant: Yun-Ting Yang, TAICHUNG (TW)

(72) Inventor: Yun-Ting Yang, TAICHUNG (TW)

(21) Appl. No.: 16/779,318

(22) Filed: Jan. 31, 2020

(30) Foreign Application Priority Data
May 3, 2019 (TW) 108205515

(51) Int. Cl. H04N 5/225; G03B 17/56; A42B 3/04; F16M 13/04

(52) U.S. Cl. CPC H04N 5/2257; G03B 17/561; H04N 5/2258; F16M 13/04; A42B 3/042

(57) ABSTRACT

A driving recorder comprises a main body. The main body has a switch. A front camera is installed in one end of the main body. The other end of the main body is connected to a rear camera through a bended connecting portion. The bended connecting portion can be bended down with a bending angle from 12 degrees to 18 degrees so that when the driving recorder is installed on the helmet, it can record the driving images at the rear of the motorcycle.

### FIELD OF THE INVENTION

The present invention relates to a driving recorder. More particularly, the present invention relates to a driving recorder having a front camera and a rear camera. A downward bending angle of the rear camera can be adjusted through a bended connecting portion to record the driving situation at the rear of a motorcycle.

### BACKGROUND OF THE INVENTION

In the modern era of popularization of cars and motorcycles, people are increasingly relying on the use of cars and motorcycles as a means of travel. However, driving disputes due to drivers are also increased. How to clarify the responsibility of a traffic accident has become an important part of a traffic case.

In the past, only most cars were equipped with driving recorders. In recent years, since accidents had occurred frequently, motorcycle riders have begun to install driving recorders to protect themselves. The driving recorder for cars is bulky and cannot be waterproof, and it is obviously not suitable for adding to a motorcycle. Therefore, driving recorders that are waterproof and lightweight and easy to use for motorcycle riders are keeping coming out.

However, although there are already driving recorders specifically designed for motorcycle riders in the market, their main appeal is waterproof function, which makes the machine operating normally with no impact, even in the rain. In addition to being installed on the steerings and rearview mirrors of motorcycles, the driving recorders are also able to be installed on the helmet to reduce the risk of theft. But this design ignores one of the most prone conditions in traffic accidents, collision form rear vehicles. At present, driving recorders used on the helmets for motorcycles in the market are one-way recordings, usually recording in the direction of riding ahead. In the case of collision form rear vehicles, if there are no images from the driving recorder in the rear vehicles and no other passing vehicles can provide driving pictures, the responsibility for the traffic accident is difficult to attribute.

Therefore, the present invention is devoted to researching a driving recorder that can simultaneously record the front and rear of a motorcycle while the motorcycle is moving to improve the shortcomings of the current driving recorders and achieve better traffic security. It can also be applied in daily life to provide more comprehensive video protection.

### SUMMARY OF THE INVENTION

Therefore, the main object of the present invention is to provide a driving recorder for motorcycle drivers, which can simultaneously record forward and backward directions during the motorcycle travel.

In order to achieve the above purpose, the present invention relates to a driving recorder. The driving recorder comprises: a main body, having a motherboard inside, wherein the motherboard is electrically connected to a switch on the main body to control power on and off; a front camera, installed in one end of the main body and electrically connected to the motherboard; a bended connecting portion, installed in the other end of the main body, wherein a bending angle of the bended connecting portion is able to be changed by bending; and a rear camera, connected to the bended connecting portion to adjust an image-taken angle of the rear camera and electrically connected to the motherboard.

Preferably, two batteries are installed in the main body.

Preferably, the bending angle of the bended connecting portion ranges from 12 degrees to 18 degrees.

Preferably, a memory card slot and a USB connection hole are installed on a side wall of the bended connecting portion, and the memory card slot and the USB connection hole are covered by a protection cap, respectively.

Preferably, a sound hole is formed in the main body.

Preferably, waterproof portions are installed in junctions of the main body to the front camera and the bended connecting portion, respectively.

Preferably, a waterproof portion is installed in a junction of the rear camera to the bended connecting portion.

With this, the present invention has the advantages that in addition to adding the rear camera so that it can record rear road conditions, changing the image-taken angle of the rear camera connected to the bended connecting portion by bending the bended connecting portion can adjust the rear camera without changing the recording direction of the front camera. It enables the rear camera to record images of the rear wheel of a motorcycle. For clarification of liability for traffic accidents of collision form rear vehicles, it can provide clearer and more effective images of evidence.

### BRIEF DESCRIPTION OF THE DRAWINGS

FIG. 1 is a perspective view of a driving recorder in the present invention.

FIG. 2 is a sectional view of the driving recorder in the present invention.

FIG. 3 is a schematic diagram of a memory card slot of the driving recorder in the present invention.

FIG. 4 is a schematic diagram of a USB connection hole of the driving recorder in the present invention.

FIG. 5 is a schematic diagram showing how to use the driving recorder in the present invention.

### DETAILED DESCRIPTION OF THE PREFERRED EMBODIMENTS

Regarding the detailed content and technical description of the present invention, examples are used for further description, but it should be understood that these examples are only for illustrative purposes and should not be construed as limitations on the implementation of the creation.

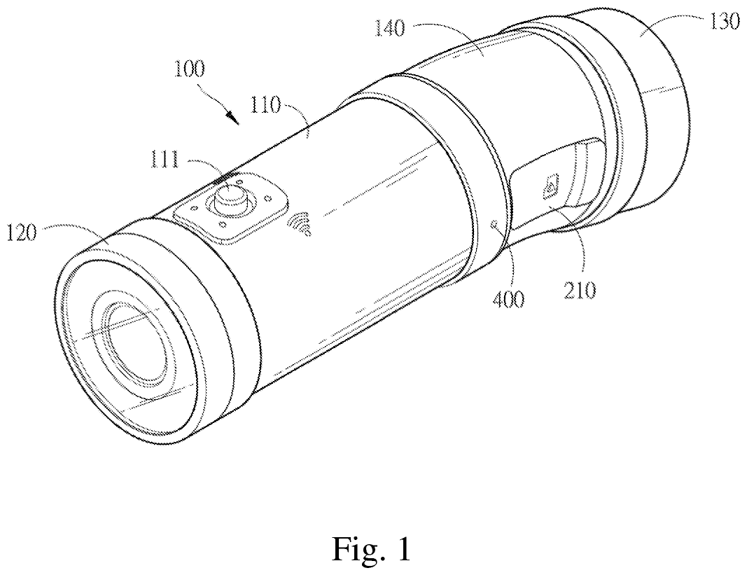

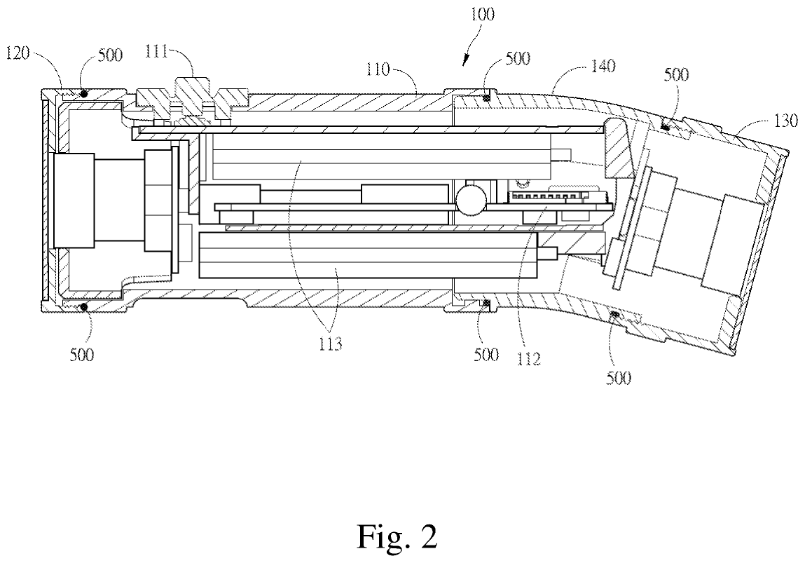

Please refer to FIG. 1 and FIG. 2. The present invention relates to a driving recorder 100. It comprises a main body 110. The main body 100 has a motherboard 112 inside. The motherboard 112 is electrically connected to a switch 111 on the main body 110 to control power on and off. Two batteries 113 are installed in the main body 110. With these two batteries 113, the driving recorder 100 can maintain a longer durability. A sound hole 400 is formed in the main body 100 for receiving sounds.

There are a front camera 120 and a rear camera 130. The front camera 120 is installed in one end of the main body 110. The rear camera 130 is connected to the other end of the main body 110 through a bended connecting portion 140. The front camera 120 and the rear camera 130 are both electrically connected to the motherboard 112.

There is a bended connecting portion 140. The bended connecting portion 140 is installed in the other end of the main body 110. A bending angle of the bended connecting portion 140 can be changed directly by bending with hands. The bending angle ranges from 12 degrees to 18 degrees. By changing the bending angle of the bended connecting portion 140, an image-taken angle of the rear camera 130 can be adjusted.

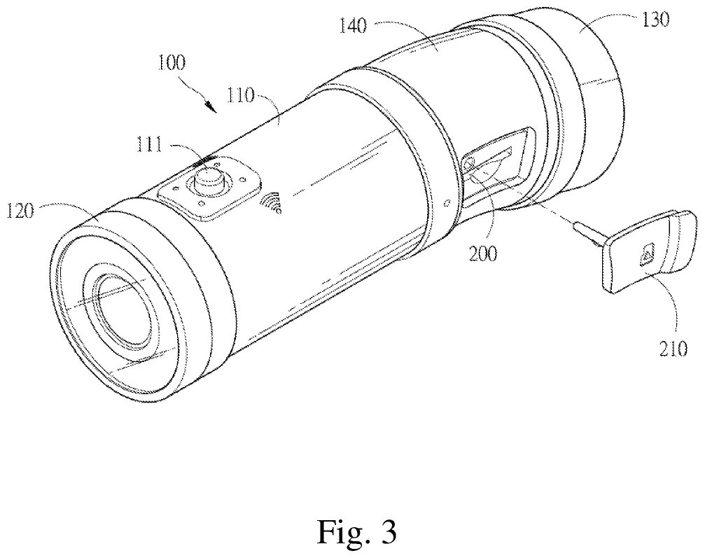

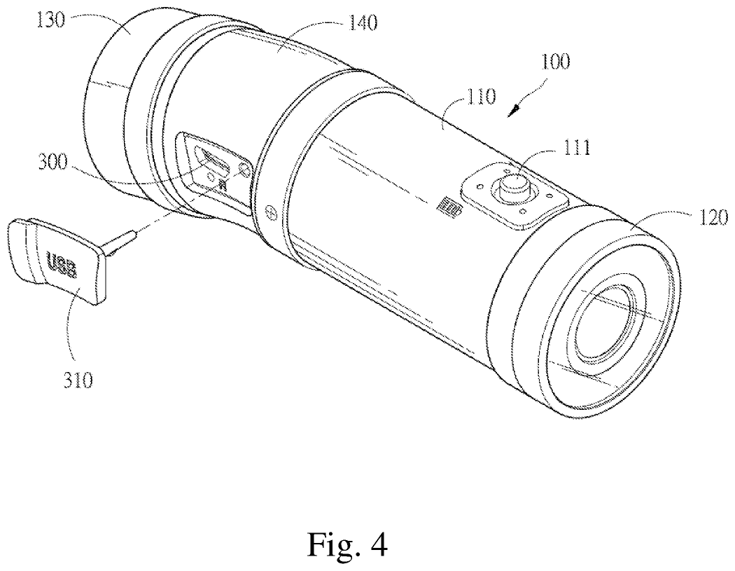

Please refer to FIG. 2, FIG. 3 and FIG. 4 at the same time. A memory card slot 200 and a USB connection hole 300 are installed on a side wall of the bended connecting portion 140. The memory card slot 200 and the USB connection hole 300 are covered by a protection cap 210 and 310, respectively. It avoids water damage. In implementation, the USB connection hole 300 is inserted by a transmission line to connect to the electric supply for charging. A memory card is inserted into the memory card slot 200 to record images.

Further, waterproof portions 500 are installed in the junctions of the main body 110 to the front camera 120 and the bended connecting portion 140, and the junction of the rear camera 130 to the bended connecting portion 140, respectively. The waterproof portion 500 is made of waterproof rubber strip, which surrounds the junctions of the above parts, for avoiding water damage to the driving recorder 100 when riding the motorcycle on a rainy day.

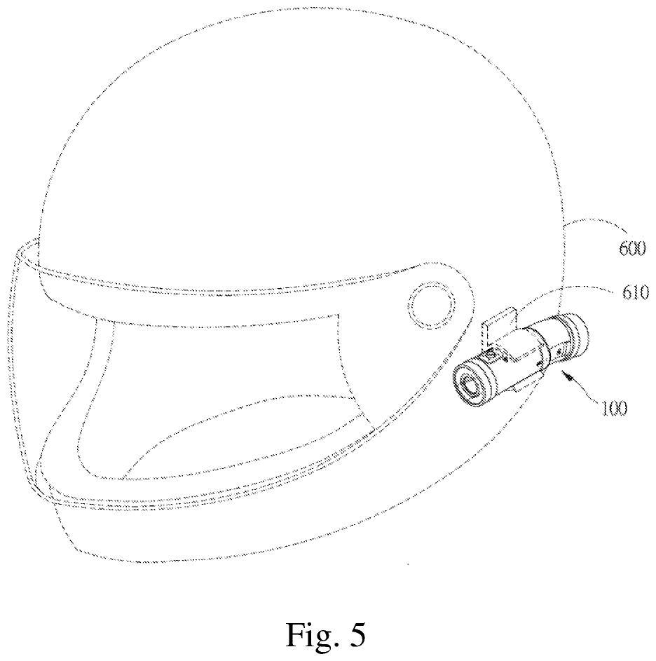

Please refer to FIG. 5. After confirming that the driving recorder 100 is fully charged and the memory card is also placed into the memory card slot 200, the driving recorder 100 can be installed on the motorcycle steering, the motorcycle rearview mirror, the helmet 600 or other places through a fixing frame 610. The use of the driving recorder 100 is not limited to driving records, but can also be applied to life records. By mounting on the backpack's shoulder strap, hat brim, and wrist through a stand, it is easy to record of living activities. The invention is best implemented by placing the driving recorder 100 on the helmet 600. When the motorcycle rider is moving, in addition to using the front camera 120 to record the images in direction of moving, the images from the rear portion of the motorcycle can also be recorded at the same time. The recording image is not limited to parallel to the front camera 120. By adjusting the angle of the connected connecting portion 140, the recording direction of the rear camera 130 can be moved down, so that the images from the rear end of the motorcycle to the rear wheel can be taken. Compared with the image-taken angle parallel to the front camera 120, it can more effectively capture key images when encountering a rear car collision or related traffic accident.

Further, a wireless transmission unit (not shown) is installed to the motherboard 112. If it is desired to transmit images taken by the driving recorder 100 to a display device, such as smartphones or computers, just turn on the switch 111 to initiate the function of wireless transmission. Connect the driving recorder 100 to the display device through one of the methods of near field communication (NFC), wireless transmission (WiFi) and Bluetooth to transfer the recorded images to the display device.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A driving recorder, comprising:
a main body, having a motherboard inside, wherein the motherboard is electrically connected to a switch on the main body to control power on and off;
a front camera, installed in one end of the main body and electrically connected to the motherboard;
a bended connecting portion, installed in the other end of the main body, wherein a bending angle of the bended connecting portion is able to be changed by bending; and
a rear camera, connected to the bended connecting portion to adjust an image-taken angle of the rear camera and electrically connected to the motherboard.

2. The driving recorder according to claim 1, wherein two batteries are installed in the main body.

3. The driving recorder according to claim 1, wherein the bending angle of the bended connecting portion ranges from 12 degrees to 18 degrees.

4. The driving recorder according to claim 1, wherein a memory card slot and a USB connection hole are installed on a side wall of the bended connecting portion, and the memory card slot and the USB connection hole are covered by a protection cap, respectively.

5. The driving recorder according to claim 1, wherein a sound hole is formed in the main body.

6. The driving recorder according to claim 1, wherein waterproof portions are installed in junctions of the main body to the front camera and the bended connecting portion, respectively.

7. The driving recorder according to claim 1, wherein a waterproof portion is installed in a junction of the rear camera to the bended connecting portion.
